(19) United States
(12) Patent Application Publication
(10) Pub. No.: US 2008/0082580 A1
(43) Pub. Date: Apr. 3, 2008

(54) Method for fundraising by providing customized items

(75) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Castineiras Companies, LLC, Hartford, CT (US)

(21) Appl. No.: 11/652,998

(22) Filed: Jan. 12, 2007

Related U.S. Application Data
(60) Provisional application No. 60/848,331, filed on Sep. 28, 2006.

(51) Int. Cl. G06F 17/30

(52) U.S. Cl. 707/104.1; 707/E17.007

(57) ABSTRACT

In a method for conducting a fundraiser inquiries are received by or solicited from an organization regarding offering at least one customized item as part of a fundraising event. A database is established for performing at least one of tracking, manipulating and storing information relevant to the fundraising event. The database includes software associated therewith. Customized items are generated and ordered that are relevant to the organization conducting the fundraiser. The orders are fulfilled and delivered to purchasers thereof.

### CROSS-REFERENCE TO RELATED APPLICATIONS

This patent application relates to U.S. Provisional Ser. No. 60/848,331, filed Sep. 28, 2006, entitled “Method for Generating Custom Postage as part of a Fundraising Event”, U.S. patent application Ser. No. 11/168,651, filed Jun. 27, 2005, entitled “Method for Generating Custom Postage Stamps”, and U.S. patent application Ser. No. 11/396,895, filed Apr. 3, 2006 entitled “Method for Generating Custom Postage as part of a Fundraising Event”. The subject matter of the above mentioned patent applications is incorporated by reference herein in their entirety.

### FIELD OF THE INVENTION

The present invention is directed to the conduct of fundraisers wherein customized items relevant to a particular organization conducting the fundraiser are offered for sale.

### BACKGROUND OF THE INVENTION

Institutions such as schools, churches, charities, affinity groups and the like often use fundraising activities to generate the capital needed to offer services or even to continue in existence. These activities typically require a great deal of planning and time to implement. In addition, they are usually “one-time” activities wherein a continuous revenue stream stemming therefrom is not realizable. In addition, these fundraising activities often have limited appeal to large population segments. Moreover, they can be logistically cumbersome as the items sold are sometimes perishable and must be gathered in a common location for distribution or to be picked up. Furthermore, the items offered for sale as part of a fundraiser are sometimes large and consume a great deal of space.

Most fundraisers offer items that are not useable year round on a continuous basis. Accordingly, the need to replenish such items is minimal. In addition, it has been historically difficult for groups to maintain a sustained year-round fundraising effort. Personnel and other logistical considerations make an ongoing campaign difficult. This is particularly true where the personnel conducting the fundraising activity consist of volunteers who may have competing obligations.

There is a current need to provide a mechanism through which an organization can conduct a sustainable fundraising event having wide appeal. To facilitate such a fundraiser, the item offered for sale must be something most people have an ongoing need for and must be easily handled. The item offered must also be something that will catch the attention of potential purchasers by, for example, being personalized or having meaning specific to the particular group.

Based on the foregoing, it is the general object of the present invention to provide a manner by which groups can conduct fundraising activities that improve upon or overcome the problems and drawbacks of prior art activities.

### SUMMARY

The present invention resides in one aspect in a method for conducting a fundraiser wherein inquiries are received or solicited from organizations regarding offering at least one customized item as part of a fundraising event conducted on behalf of the organization. A facilitating company establishes a database that performs at least one of tracking manipulating and storing information relevant to the fundraising event. Once an organization expresses an interest or states that it wishes to conduct a fundraiser, the facilitating company provides instructions to the organization regarding the manner by which the fundraiser will be conducted. Prior to the solicitations of any orders for customized items, at least one image relevant to the organization is created for display on at least one customized item. Subsequent to creation, the image is provided to the organization for approval and once approved will be displayed on the customized items.

Viewing means are provided via which at least one of the customized items can be viewed. The viewing means are unique to the organization and are accessible via notice and instructions from or on behalf of the organization. Once the organization has had the opportunity to view the customized items, orders are received including payment instructions. At least a portion of the database is populated with information relevant to the orders received. Following processing of payment, the orders are fulfilled and the customized items are delivered to purchasers thereof either directly or via distribution by the organization conducting the fundraiser.

In an embodiment of the present invention, the organization is an affinity group. As used herein, the term “affinity group” should be broadly construed to mean “a group of people sharing a common interest”. In addition, the term “customized items” should be broadly construed to include, inter alia, custom postage, customized checks, customized mailing labels, customized wrapping paper, calendars, and the like.

In another aspect of the present invention the above-described images displayed on the customized items are created by the participants in the fundraiser. To facilitate the creation of original artwork by the participant, artforms are created by the facilitating company and distributed to the organization. The artform may not need to be created each time an organization conducts a fundraiser. The artform can be a stocked item on hand for immediate delivery. Once the organization or the facilitating company has distributed the artforms to the fundraiser participants, each participant creates the original work of art on the art form. Orders are then solicited by the participants in the fundraiser for customized items, such as, for example customized checks or mailing labels that bear images of the participant's artwork thereon. As part of the order solicitations process, payment information such as credit or debit card numbers is also obtained. The artforms and order information are then forwarded to the facilitating company or entity acting on behalf of the facilitating company and electronic images of each participant's artwork are created. While the method of the present invention has been described in a manner wherein orders are solicited by the participants, the present invention is not limited in this regard. Orders may also be entered via phone, fax, mail, e-mail, or via a website established for, inter alia, accepting orders, without departing from the broader aspects of the present invention.

The electronic image is stored and associated in the database with other information relevant to the particular organization and the participant in the fundraiser. While this embodiment has been described as having the participants solicit orders and forward their artwork along with the ordering information to the facilitating company or an entity on behalf thereof, the present invention is not limited in this regard. This embodiment of the present invention also contemplates that the original artwork be converted into electronic format prior to orders being solicited, and the orders being taken via a webpage whereon the customized items such as, custom checks, custom mailing labels, and/or wrapping paper bearing images of the original artwork thereon are displayed.

Preferably, the organization referred to above is a school or school system or an affinity group. However, the present invention is not limited in this regard as other types of organizations, such as charities or even individuals attempting to raise money to cover medical expenses for another person are contemplated by the present invention.

Once the orders and payment information is received, the orders are processed and shipped to the respective purchasers.

### DETAILED DESCRIPTION OF THE PREFERRED EMBODIMENTS OF THE PRESENT INVENTION

The present invention is directed to a method for conducting a fundraiser whereby inquiries are received by, or solicited from, an organization regarding offering at least one customized item as part of a fundraising event conducted on behalf of the organization. A database is maintained for tracking the solicitation or inquiry. Information resident in the database relevant to the fundraiser can be tracked, manipulated and/or stored therein via software associated with the database. Preferably this software can also be employed to extract information from the database to generate desired outputs. For example, at the conclusion of the fundraiser, a portion of the proceeds will be due the organization. The software associated with the database can be used to extract the information therefrom relevant to the amount due the organization and can be employed to generate a report pertaining thereto. The software described above can be part of a purchased database package, such as, for example, Microsoft Access® program, the software can be third party software, or the software can be customized software written for the facilitating company. Moreover, the database may be established and/or managed by the facilitating company or a third party acting on behalf of the facilitating company. In addition, at the conclusion of a fundraising event, the organization conducting the fundraiser may retain the portion of the collected funds due it and forward the remainder to the facilitating company or an entity designated by the facilitating company. Similarly, the organization conducting the fundraiser can collect all of the payments from purchasers of the customized items and present the facilitating company with a single reconciled payment. This reconciled payment can be in the form of any of the above-described payment instructions. Moreover, the organization conducting the fundraiser may or may not withhold the amount due it.

Once the organization has agreed to conduct a fundraiser, instructions are provided to the organization. At least one image relevant to the organization is created, by or at the behest of the company facilitating the fundraiser for display on the customized items. Preferably several images are created so that the organization can have a broad selection of images to choose from. Each of the images created will have significance relevant to the organization for which the fundraiser is being conducted. For example if the organization is an affinity group, such as an alumni association, the images may include scenes of the relevant university campus or buildings thereon. The images can also include logos or sports team images relevant to the university. However, the present invention is not limited in this regard as other images relevant to the particular organization such as, for example, images of distinguished or famous past or present members of the organization, can be created without departing from the broader aspects of the present invention. Once the images are created the organization chooses one or more of the images for inclusion on the customized items.

The above-described customized items can include such things as custom postage, custom note cards, return labels, mugs, key chains and the like, each bearing at least one of the images thereon. In addition, the customized items can also include wrapping paper. The wrapping paper would include one or more of the images printed thereon. In addition, a purchaser may also be able to select a theme pattern and/or color scheme for the wrapping paper. The theme could be relevant to a holiday or be event specific, such as for example a birthday theme or anniversary. Where a holiday theme is provided, a potential purchaser can be presented with several choices relevant to a particular theme. For example, for a Christmas theme, the wrapping paper could include images and/or phrases unique to Christmas. In addition, the user or prospective purchaser can also be presented with several choices as to color or a color scheme for the wrapping paper. Since the wrapping paper bears the above-described image or images unique to the particular organization the color scheme that is chosen may be complimentary to the color within the particular image or images.

Viewing means unique to the organization and accessible via notice therefrom or on behalf thereof, are provided by which at least one customized item having the at least one image displayed thereon can be viewed by the organization. In the preferred embodiment of the present invention the viewing means includes a web page having an URL unique to the organization. The webpage can also be protected via security protocols, such as, but not limited to, a password. In addition to being able to view the custom items on the webpage, a user accessing the page may also be able to make choices with respect to colors or patterns to be included on the custom items. For example, where a user is purchasing customized wrapper paper, via the webpage or links included thereon, a user or prospective purchaser may be able to choose a theme, color scheme, pattern, and the manner by which the images will be displayed on the wrapper paper. In the preferred embodiment of the present invention, once the webpage is established the facilitating company either notifies the organization which then contacts those participating in the fundraiser, or the facilitating company, based on a list provided by the organization, will contact the participants in the fundraiser advising them of the manner by which the webpage can be accessed.

Orders for the customized items are received by the facilitating company, preferably by placing the orders electronically via the webpage at which the custom items are viewed. Ordering information may be accessible directly on the webpage or via a link to an ordering page, the link being on the webpage at which the custom items are viewed. While electronic ordering has been described, the present invention is not limited in this regard as other ordering means can be employed, such as, ordering via the mail, fax or telephone. Moreover, while electronic ordering information via the webpage, or a link on the webpage where custom items can be viewed has been described, the present invention is not limited in this regard as orders may be placed electronically via a wholly separate webpage or website that is not accessible via a link on the webpage where the custom items are viewed.

In addition to ordering custom items in the above-described manner, payment information and order information regarding which, and the quantity of customized items ordered must also be ultimately transmitted to the facilitating company. Payment information/instructions is received and processed by the facilitating company or another entity on behalf of the facilitating company. These payment instructions can take several different forms. For example, payment may be made electronically by credit or debit card by entering the relevant information into a payment section of the above-described webpages or via a separate payment webpage. The credit or debit card information along with the ordering information is then forwarded to the facilitating company for processing. Payment information can also be processed by accessing an internet payment system, such as, for example, Paypal®. While electronic payment has been described, the present invention is not limited in this regard, as payment may also be made by cash, checks or money order, or via credit or debit card with the credit or debit card information being transmitted by fax, mail, e-mail, or the like.

Subsequent to, or simultaneously with the placement of an order, the above-described database is populated with information relevant to the received orders. The database may be populated manually or directly if the orders are placed electronically. If the database is populated directly, it may be necessary for the software associated with the database to operate to facilitate the population thereof. The order information entered into the database may include such things as the name of the person placing the order, the type and number of custom items ordered, the organization for which the particular fundraiser is being conducted, the method of payment and the shipping address to which the custom items are to be sent.

Once the necessary information is received, the orders are fulfilled and the custom items sent to the purchasers thereof. Upon completion of the fundraiser, the facilitating company calculates, either manually or by employing the software associated with the database, the percentage of the proceeds that are due to the organization and once calculated forwards the funds to the organization. In addition, a portion of the proceeds from the fundraiser may be allocated to a scholarship or other type of assistance fund. For example, a fund used to defray medical expenses of the members or others designated by the organization conducting the fundraiser may be established. This fund may be managed by the facilitating company or another organization.

The software associated with the database can have the ability to manipulate the information in the database to generate desired outputs. For example, financial reports, demographic reports, and the like may be generated. The term “associated” used herein with respect to the phrase “software associated with the database” should be construed to mean software that is in communication with the database or upon use can communicate with the database to manipulate information stored therein or to facilitate the storage of information therein.

In an embodiment of the present invention, custom postage, customized checks, and/or customized mailing labels are offered as part of a fundraising event. Initial information is collected from the organization and stored in the database. The initial information can include such things as the organization's name, address, phone number, e-mail address and the name of a contact person within the organization. However, the present invention is not limited in this regard as other or different information may also be initially requested without departing from the broader aspects of the present invention.

Upon receipt of the initial information a unique organization identification code is established and associated with the initial information stored in the database. The organization code can be generated by the software associated with the database automatically upon entry of the initial information into the database. The organization code may also be established manually and manually associated with the relevant information stored in the database. The organization identification code can be random or be as straightforward as the organization's name.

Once entered, information is extracted from the database and used to generate artforms upon which participants in the fundraising event can create their own unique artwork. The artforms are preferably made from paper with a portion of the form delineated as the area of the artform on which the original artwork is to be created. The organization identification code is associated with the artforms, preferably in the form of a bar code printed directly on the artforms. However, the present invention is not limited in this regard as other indicia such as, for example, a form number, can be associated with the organization code without departing from the broader aspects of the present invention. Once generated, a plurality of the artforms is distributed to the organization and thereby to the participants in the fundraising event. It may not be necessary for the facilitating company to generate the artform as they may also maintain a stock of the artform on hand. In such instances and as described above, it may only be necessary to associate a number or other indicia on the artform with the organization code. However, the present invention is not limited in this regard as there may also be no need to associate the particular artforms with the organization prior to their distribution. Alternatively, the artform may be forwarded directly to the participant via mail or e-mail. In addition, the artform may be resident on a webpage dedicated to the particular organization and downloadable therefrom.

Once the participants in the fundraiser are in possession of the artforms, the participants produce the original artwork thereon, preferably by drawing onto the artform. However, photographs or other materials, such as, but not limited to stickers materials “cut-out” from other sources, may also be placed on the artforms. Once the original artwork is completed, participants solicit orders for custom postage, custom checks, or mailing labels, bearing the participant's artwork thereon. Purchasers may also have the option of soliciting orders for other customized items, bearing images of the relevant artwork, such as note cards, key chains, signs and the like. Conversely, images of the custom postage, custom checks, or mailing labels, bearing the participant's artwork thereon may be posted on a webpage for viewing by potential purchasers. Preferably, the webpage is unique to the particular organization conducting the fundraiser and accessible via password or other security protocol generated by the facilitating company and disseminated to prospective purchasers by or on behalf of the organization conducting the fundraiser. While the dissemination of the above-described password has been described as being accomplished by the organization conducting the fundraiser, the present invention is not limited in this regard as the facilitating company; pursuant to information concerning prospective purchasers provided to it by the organization may also notify the prospective purchasers with respect to how to access the appropriate webpage. While the webpage has been described as being unique to the organization, it may in addition, be unique to the particular individual's artwork. Accordingly, an organization may have a plurality of unique web pages and URL's associated therewith, each being relevant to the particular organization and/or fundraiser and to a particular participant's artwork.

The artforms and information relevant to any solicited orders as well as information identifying each of the participants is collected and forwarded to the company facilitating the fundraising event or another entity designated by the facilitating company. In the preferred embodiment of the present invention, the original artwork and ordering information are embodied in the artforms. However, the present invention is not limited in this regard as information relevant to solicited orders can reside somewhere other than on the artform. For example, a separate order form can be utilized.

Once the artforms and ordering information are received, payment information relevant to purchasers of said custom postage is extracted from the ordering information and processed. Where web pages are employed for placing orders, credit or debit card information may be entered electronically via the particular webpage or an order entry page linked to the webpage. This information is then processed by the facilitating company and if any problems occur in processing a payment, the payer is contacted and the situation resolved. In addition, the organization can collect all of the payments from potential purchasers and issue one reconciled payment to the facilitating company. If this system of payment is employed, orders may be placed via the above-described web pages. In such an instance, the organization can be provided from the facilitating company with an accounting of the amounts owing and from whom. The organization can then, as described above, forward a reconciled payment to the facilitating company in any of the above-described manners.

In addition, when the artform and any other material is received, at least a portion of the information contained on the artform and other materials may be entered into the database. Each piece of artwork is scanned and along with information relevant to the orders as well as information identifying each of the participants, is entered into the database. All of this information is associated with the relevant organization identification code and a unique participant identification code for each participant is created and associated with the information stored in the database relevant to the participant, as well as with the relevant organization identification code. However, the present invention is not limited in this regard as a unique participant identification code is not required to enable this particular embodiment. Printing information for the custom postage, custom checks, and or customized return labels, bearing the participants artwork is generated and used to cause the customized item(s) to be printed. Once printed, the customized item(s) is shipped to the purchasers thereof.

While images created by participants in the fundraiser have been described as being printed onto checks and mailing labels, the present invention is not limited in this regard. For example, where the organization is an affinity group, images relevant to the particular affinity group may be created, as described above, by the facilitating company. These images, once approved by the affinity group, can then be printed onto customized items including checks, mailing labels, note cards and the like.

In another embodiment of the present invention, the above-described images created on behalf of an affinity group can take the form of paintings or photographs created at the behest of the facilitating company. In addition signed images by prominent figures such as sports figures, famous alumni and the like, can also be provided. The originals, or copies, such as posters or lithographs can also be offered as part of the fundraiser, as can commemorative plaques incorporating the images. In addition, the present invention contemplates these items being auctioned off on line either at a web site or web page established by or on behalf of the organization, or at an on-line auction site such as, but not limited to EBAY®.

Where original artwork is created by participant in the fundraising event as described above, this artwork can also be offered to prospective purchasers in the form of prints or posters. Moreover, commemorative plaques and/or collages or compilations of the artwork may also be offered including things such as calendars incorporating the artwork.

The present invention also contemplates designating selected original artwork as embodied on custom postage as collectable. Submitted artwork would be reviewed by the facilitating company or by designers of the facilitating company. If a fundraiser participant's original artwork is selected, custom items, including custom postage would be designated as collectable and offered for sale to the general public. The organization that originally conducted the fundraiser relevant to the particular selected piece of original artwork will then receive a portion of the proceeds of the sales to the general public. In addition, the artist responsible for the original artwork will be eligible to receive a scholarship.

In still another embodiment of the present invention, once an organization commits to conducting a fundraiser whereby the above-described artforms are employed, barcodes are placed on preprinted artforms. Preferably, the barcode has 15 digits that pertain to the following information. Four digits forming part of the barcode correspond to an identification number unique to the organization conducting the fundraiser. Two digits forming part of the bar code identify the particular state that the organization or the fundraiser are located in. Four digits corresponding to the particular bar code identify the relevant year, and the last five digits identify the number of the particular artform. While a particular sequence and number of digits has been described as forming the barcode, the present invention is not limited in this regard as the number of digits, their order, and what they pertain to can be changed without departing from the broader aspects of the present invention.

Once an artform is completed and submitted to the facilitating company, the barcode is scanned by conventional means. The scanned information extracted from the barcode identifies the artwork on the particular artform, the organization, the location and date(s), and the consumer and ties all of this information together. The scanned information can, via the software associated with the database, be transferred and stored directly in the database, and subsequently reviewed for accuracy, or the scanned information can first be subject to review for accuracy and then be input into the database.

In still another embodiment, customized wrapping paper can be offered as part of the fundraising event. The wrapping paper can include images of the original artwork thereon, personal photographs, combinations thereof, and the like. In addition, the wrapping paper can have various different themes, color schemes and patterns associated with it. These may all be selectable by the purchaser.

In the above-described embodiments wherein the images are posted on a website accessible by potential purchasers of the customized items, wrapping paper images can also be displayed thereon or be accessible via a link therefrom. Once the wrapping paper images are available to the prospective purchaser, several different options may be available to customize the wrapping paper. For example, different patterns and/or color schemes for the wrapping paper may be selectable. Moreover, the prospective purchaser may be able to select the manner in which the images and/or artwork appear on the wrapping paper. In addition, the wrapping paper incorporating predetermined images and/or original artwork, or a combination thereof, may also be thematic in nature. For example, the wrapping paper could have a theme and patterns thereon indicative of a holiday, such as Christmas. In addition, the theme could be relevant to a particular event such as a birthday or anniversary. Accordingly, the prospective purchaser may wish to procure more than one type of wrapping paper, customized to have one or more desired images thereon.

In addition to original artwork, the custom wrapping paper can bear images selected from a gallery of images provided by the facilitating company. These images may be accessed from a webpage accessible by a prospective purchaser. Where original artwork is being displayed thereon, more than one piece of artwork may be placed on the wrapping paper. For example, it may be desirable to have the artwork of two or more siblings displayed on the wrapping paper.

In addition, the present invention also contemplates incorporating other images such as photographs into the wrapping paper. For example, where a school is conducting the fundraiser, a child's school picture, alone or in combination with a class picture or other picture may be incorporated into the wrapping paper. In this instance these pictures would preferably be supplied to the facilitating company in electronic format for incorporation into the wrapping paper. However, the present invention is not limited in this regard as the photographs can also be provided to the facilitating company or entity acting on behalf of the facilitating company who then would convert them into an electronic format. Preferably, the images as well as the wrapping paper themes, patterns and color schemes will be internet accessible in the above described manner. However, the present invention is not limited in this regard as the wrapping paper themes, patterns, color schemes and images for incorporation thereon can be manually selected without and forwarded to the facilitating company for production.

In a related embodiment of the present invention, the artform is created by the fundraiser participants on-line. In this instance, the creator of the artwork, or if the creator is a child, or not computer literate, someone on behalf of the creator accesses a webpage established to provide instructions for and to facilitate scanning the artwork onto an on-line artform. Once the relevant webpage is accessed, the appropriate barcode, previously provided to the creator, is typed into an area provided on the webpage. The creator or other person is then walked through, via on-line instructions, the process of scanning the artwork from their home or other location. Once the artwork is scanned into the relevant webpage the creator or other person will also be able to, via online instructions, customize the particular item or items he/she wishes to order. For example, if custom postage is being ordered, the purchaser will be able to, on-line, change certain colors on the postage. If custom checks or mailing labels are ordered, the person may have the option of selecting different check or label backgrounds fonts and/or print colors. Similar modifications may also be made to other custom items offered as part of the fundraiser.

In still another embodiment of the present invention, gift cards are offered as part of the fundraising event or as an item for purchase after the fundraising event. The gift cards can be purchased in predetermined amounts, such as, but not limited to $25 or $50. Similarly, the gift card can be encoded with any amount.

Each gift card has a number or code printed thereon. This code is unique to one or both of a particular organization or an individual participant in a fundraiser. Where the organization is an affinity group, the code is unique to the particular group. Where the organization is a school, the code may be unique to the particular participant in the fundraiser.

These gift cards may be offered as part of the fundraiser or after the fundraiser is over. The gift cards may have a finite period of usefulness, corresponding to a period of time for which customized items bearing a particular image are available.

In practice, the gift cards can be ordered either via a webpage unique to a particular organization or containing ordering information unique to one or more particular individuals. The gift cards bearing a number associated with a particular organization and/or individual are forwarded to the purchaser.

Once received, the purchaser accesses a particular web page identified on the gift card or on instructions supplied with the gift card. The purchaser then enters the code on the gift card and is directed to a webpage whereon customized items associated with the code on the gift card can be viewed and purchased using the card. While the present invention has been described wherein the gift card is used to purchase customized items associated with the barcode on the gift card, the present invention is not limited in this regard as other custom items separate from those associated with the code on the gift card can also be purchased without departing from the broader aspects of the present invention.

The information relevant to each gift card, such as, but not limited to, purchaser name and address, relevant organizations and/or image, and/or individual are stored in the database. This information can be stored directly to the database via software associated therewith or the information can be manually entered into the database. When a purchase is made using a gift card, the database is updated either manually or automatically to reflect what was purchased and to adjust the dollar amount, if any, left on the gift card.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for conducting a fundraiser, said method comprising the steps of:
soliciting, or receiving an inquiry from an organization regarding offering at least one customized item as part of a fundraising event conducted on behalf of said organization;
establishing a database for performing at least one of tracking, manipulating and storing therein, information relevant to said fundraising event, said database having software associated therewith for manipulating said information stored in said database to generate desired outputs;
providing instructions to said organization regarding the manner in which said fundraiser will be conducted;
causing at least one image relevant to said organization to be created, said image to be displayed on said customized items;
providing said organization with said at least one image for approval thereof;
providing said organization with viewing means by which said at least one customized item having said at least one image displayed thereon can be viewed, said viewing means being unique to said organization and accessible only via notice from or on behalf of said organization;
receiving orders for said customized items;
receiving and processing payment instructions for said orders;
populating at least a portion of said database with information relevant to said received orders;
fulfilling said orders; and
delivering said customized orders to purchasers thereof.

2. A method as defined by claim 1 wherein said step of causing said at least one image relevant to said organization to be created further includes the steps of:
a company facilitating said fundraiser creating or causing to be created a plurality of different images, each being relevant to said organization;
said organization selecting at least one of said plurality of images for inclusion on said customized items;
said step of providing said organization with viewing means includes establishing a webpage having a URL specific to said organization wherein said customized items bearing said selected images can be viewed, and wherein
said step of receiving orders includes a purchaser entering ordering and payment information electronically.

3. A method as defined by claim 2 wherein said organization is an affinity group.

4. A method as defined by claim 2 wherein said webpage requires user identification information, unique to said organization, to be entered prior to gaining access to said webpage.

5. A method as defined by claim 2 wherein said step of entering payment information electronically includes, entering credit or debit card information into a designated area of said webpage.

6. A method as defined by claim 5 wherein said designated area is accessible via a link on said webpage.

7. A method as defined by claim 1 wherein:
following said step of soliciting or receiving an inquiry, said method includes the further step of collecting initial information from said organization and storing said initial information in said database.

8. A method as defined by claim 1 wherein said step of processing said payments includes, accepting payments by one or more of cash, check, and credit card.

9. A method as defined by claim 8 wherein said step of processing said payments further includes accessing said web site and activating a link to an internet based payment system and completing an electronic funds transfer thereby.

10. A method as defined by claim 3 wherein said affinity group is an alumni association.

11. A method as defined by claim 1 wherein said step of receiving said order information includes transmitting said order information electronically and wherein at least a portion of said electronically transmitted order information is transferred into said database upon transmission, said software associated with said database causes said at least a portion of said electronically transmitted order information to be input into said database and associated with the relevant organization.

12. A method as defined by claim 1 wherein said customized items includes custom postage displaying said at least one image thereon.

13. A method as defined in claim 12 including the further steps of providing means for allowing a purchaser to further customize portions of said custom postage.

14. A method as defined by claim 1, further comprising the steps of:
compiling financial information relevant to a total amount of purchases made during the course of the fundraiser;
calculating a percentage of said total amount to be sent to said organization; and
forwarding an amount of money relevant to said percentage, to said organization.

15. A method as defined by claim 1 further including the step of offering said custom postage in commemorative form to said organization.

16. A method as defined by claim 1 including the further step of reserving a portion of an amount of money collected during said fundraiser in a fund used for the awarding of scholarships by said organization.

17. A method as defined by claim 16 wherein said scholarship fund is administered by an entity facilitating said fundraiser.

18. A method as defined by claim 1 wherein said customized items include checks displaying said at least one image thereon.

19. A method as defined by claim 18 wherein said method includes the further steps of providing means for allowing a purchaser to customize portions of said check.

20. A method as defined by claim 19 wherein said portions of said check include at least one of a background, lettering font, lettering color, and border color.

21. A method as defined by claim 1 wherein said customized items include return address labels.

22. A method as defined by claim 21 wherein said method includes the further step of providing means for a purchaser to customize portions of said return labels.

23. A method as defined by claim 1 wherein said customized items includes wrapping paper.

24. A method as defined by claim 23 wherein said step of providing said organization with viewing means include establishing a webpage having a URL specific to said organization at which said wrapping paper can be viewed.

25. A method as defined by claim 24 wherein said webpage is configured to allow the user to customize said wrapping paper; and wherein said method includes the further steps of:
a prospective purchaser accessing said webpage and selecting at least one of a theme, color scheme, image, and pattern for said wrapping paper.

26. A method as defined by claims 23 wherein said organization is an affinity group.

27. A method as defined by claim 26 wherein said step of causing said at least one image relevant to said organization to be created, includes causing a plurality of said images to be created; and wherein said steps of selecting a pattern further includes choosing two or more of said images for inclusion on said wrapping paper; said method further including the step of
determining the placement pattern of said images on said wrapping paper; said webpage displaying an image of said customized wrapping paper created by said prospective purchaser.

28. A method for conducting a fundraiser, said method comprising the steps of:
soliciting or receiving an inquiry from an organization regarding offering at least one of customized postage, customized checks, and customized return labels as part of a fundraising event conducted on behalf of said organization;
establishing a database for performing at least one of tracking, manipulating, and storing therein, information relevant to said fundraising event, said database having software associated therewith for manipulating said information stored in said database to generate a desired output;
distributing a plurality of artforms to said organization, said organization then distributing at least one artform to each participant in said fundraiser;
each of said participants creating original artwork on at least one of said artforms;
taking orders including payment information for at least one of custom postage, customized checks, and customized return labels, relevant to at least one of said participants original artwork;
creating an electronic image of each participants original artwork;
storing and associating the image with the relevant organization said electronic images, information relevant to said orders and payment information in said database, said electronic images, information relevant to said orders, and payment information being associated within said database with the relevant organization and participant in said fundraiser; and
processing said payment information and upon receipt of payment fulfilling said orders.

29. A method for conducting a fundraiser as defined by claim 28 wherein said organization is one of a school, a charity, and an affinity group.

30. A method for conducting a fundraiser as defined by claim 28 wherein said step of distributing a plurality of artforms to said organization further includes:
printing a barcode on each artform prior to distribution to said participant and said organization, said barcode being unique to said organization;
said step of creating an image of each participants original artwork further comprising;
establishing a webpage accessible by or on behalf of a participant in said fundraiser, said webpage providing instructions for and aiding in the facilitation of scanning the original artwork into an on-line form;
entering said barcode into a designated area of said webpage; and
scanning an image of said original artwork into said on-line form pursuant to said instructions provided on said webpages.

31. A method as defined by claim 30 providing the further step of:
providing means, once said original artwork is scanned into said on-line form, for at least one of said consumer and said participant to customize portions of said scanned image.

32. A method as defined by claim 31 wherein customized checks are being offered as at least part of said fundraising event, and wherein said step of providing means for at least one of said consumer and said participant to customize portions of said scanned image further includes;
providing means for customizing at least one of a check background, a check border, text font, and text color.

33. A method as defined by claim 31 wherein customized return labels are being offered as at least part of said fundraising event and wherein said step of providing means for at least one of said consumer and said participant to customize portions of said scanned image further includes providing means for customizing at least one of a label background, a label border, text font, and text color.

34. A method as defined by claim 28 wherein said barcode includes digits corresponding to identifying said organization, a state in which the organization resides or where the fundraiser is being conducted, the relevant year, and digits identifying a particular artform.

35. A method as defined by claim 28 wherein said barcode includes fifteen digits, four digits correspond to an identification number unique to said organization, two digits identify the particular state that the organization or the fundraiser are located in, four digits identify the relevant year, and five digits identify a particular one of said artform.

36. A method as defined by claim 1 wherein said customized items include gift cards, said gift cards displaying a code thereon unique to said organization and said at least one customized item having said at least one image displayed thereon; said step of receiving orders including receiving orders for said gift cards, said purchaser selecting a value to be associated with said gift card; and
causing said code to be displayed on said gift card and stored in said database.

37. A method as defined by claim 36 wherein following receipt of said gift card, said step of receiving and processing payment instructions includes a bearer of said gift card providing said code displayed on said gift card to pay for said customized items corresponding thereto; and
updating said database to reflect any value remaining on said gift card.

38. A method as defined by claim 28 wherein said step of taking orders includes taking orders for gift cards each having a code displayed thereon, said code being unique to at least one of a particular participant and a particular participants original artwork;
a purchaser of a gift card choosing a value to be associated therewith; and wherein
said steps of fulfilling said orders includes shipping said gift cards to purchasers thereon.

39. A method as defined by claim 38 wherein,
following receipt of said gift card, said step of taking orders including payment information, includes a bearer of said gift card using said code displayed on said gift card to pay for said customized items corresponding thereto; and
updating said database to reflect any value remaining on said gift card.

40. A method as defined by claim 38 wherein said step of creating an electronic image of each participants original artwork occurs prior to said step of taking orders.

41. A method as defined by claim 28 wherein said step of taking orders occur after said steps of creating an electronic image.

42. A method for conducting a fundraiser, said method comprising the steps of;
soliciting or receiving an inquiry from an organization regarding offering customized wrapping paper as part of a fundraising event;
establishing a database for performing at least one of tracking, storing, and manipulating therein, information relevant to said fundraising event, said database having software associated therewith for manipulating said information stored in said database to generate a desired output;
distributing a plurality of artforms to said organization, said organization then distributing at least one artform to each participant,
at least one of said participants creating original artwork on at least one of said artforms;
creating an electronic image of said original artwork and storing said electronic image in said database
establishing at least one webpage accessible by potential purchasers of said wrapping paper where said potential purchasers can selectively view images of said wrapping paper thereon, said images of said wrapping paper incorporating said original artwork thereon;
accepting orders for said wrapping paper; and
processing and shipping said orders for said wrapping paper to purchasers thereof.

43. A method as defined by claim 42 wherein:
upon accessing said webpage, viewing means are provided to allow said prospective purchaser to view said wrapping paper incorporating a particular participants original artwork.

44. A method as defined by claim 43 wherein said webpage is configured to allow the user to customize said wrapping paper; and wherein said method includes the further steps of
a prospective purchaser accessing said web page and selecting at least one of a theme, color scheme, and pattern for said wrapping paper.

45. A method as defined by claim 1 wherein said step of receiving and processing payment instructions includes said organization collecting payment for said orders, detecting an amount due for said orders to said organization and receiving a single payment instruction from said organization for said customized items.

46. A method as defined by claim 28 wherein said step of receiving and processing payment instructions includes said organization collecting payment for said orders, detecting an amount due for said orders to said organization and receiving a single payment instruction from said organization for said customized items.

47. A method as defined by claim 28 wherein said customized item includes custom postage and said method comprises the further steps of:
designating at least one particular piece of custom postage bearing said original artwork as collectible custom postage;
offering said collectible postage to the general public for purchase; and
designating at least a portion of any proceeds derived from the sale of said collectible custom postage as being due said organization that held the fundraiser for which said original artwork was created.

48. A method as defined by claim 47 comprising the further steps of:
making artist who created said original artwork born on said collectible custom postage eligible for a scholarship award; and
awarding at least one scholarship to at least one of said artists.
